(19) United States
(12) Patent Application Publication
(10) Pub. No.: US 2013/0271408 A1
(43) Pub. Date: Oct. 17, 2013

(54) TOUCH SCREEN AND MANUFACTURING METHOD THEREOF

(71) Applicant: TPK TOUCH SOLUTIONS (XIAMEN) INC., Xiamen City (CN)

(72) Inventors: Yanjun Xie, Wuhan City (CN); Yau-Chen Jiang, Zhubei City (TW); Bin Lai, Fuzhou City (CN)

(73) Assignee: TPK Touch Solutions (Xiamen) Inc., Xiamen City (CN)

(21) Appl. No.: 13/864,246

(22) Filed: Apr. 17, 2013

(30) Foreign Application Priority Data
Apr. 17, 2012 (CN) 201210113760.4

(51) Int. Cl. G06F 3/041

(52) U.S. Cl. CPC G06F 3/041
USPC 345/173; 427/98.4; 427/97.3

(57) ABSTRACT

The present &closure provides a touch screen, wherein the touch screen includes: a protecting cover comprising a touch area and a border area surrounding the touch area; a black mask layer farmed on the border area; and a conductive assembly formed in the touch area, Wherein the conductive assembly is isolated from the black mask layer. By using the touch screen provided in the present disclosure, the problem of easy breaking of the conductive assembly Which leads to functional failure of a touch screen in the conventional technology can be solved. In addition, the present disclosure also provides a manufacturing method of the foregoing touch screen.

This application claims the benefit of Chinese application No 201210113760:4, filed on Apr. 17, 2012.

### TECHNICAL FIELD

The present disclosure relates to a touch screen, and more particularly, to a. touch screen funned on a protecting cover and a manufacturing method thereof

### BACKGROUND

Currently, electronic products combined with touch functions have become the mainstream of development in the market for consumer electronics. Touch screens have been used in various kinds of electronic products, such as smart phones, mobile phones, tablet computers, and laptops, etc. Since a user can these days directly operate and give instructions through the objects displayed on a screen, the touch screen provides a humanized operating interface between the user and the electronic product.

At present, common technologies involved in manufacturing of touch screens include resistive type, capacitive type and acoustic wave type. As shown in FIG. 1, a traditional touch screen 1 includes a protecting cover 100, a black mask layer 11, a conductive assembly 12 and conductive wires 13. The protecting cover 100 comprises a touch area 111 and a border area 112 surrounding the touch area 111. The black mask layer 11 covers the border area 112 to make the protecting cover 100 seem to have a black border. The conductive assembly 12 is placed on the touch area 111 and is extended to some parts of the black mask layer 11. The conductive wires 13 are disposed on the black mask layer 11 and electrically connected to the conductive assembly 12, which transmit signals on the touch screen 1 to an external circuit such that the external circuit can determine a touch location on the touch screen 1 according to the signals. Effects of the black mask layer 11 lie in: in one aspect, in a borderless design, a visual effect of haying a border is presented on the appearance of an electronic device so as to meet users demand or overall appearance of an electronic device; in the other aspect, it is used to mask the conductive wires 13 disposed thereon.

As mentioned above, the conductive assembly 12 is extended from the touch area 111 to some parts of the black mask layer 11 such that the conductive assembly 12 electrically connects to the conductive wires 13 placed on the black mask layer 11. However, the thickness of the black mask layer 11 has a certain thickness such that there is a certain height difference between the conductive assembly 12 located on the border area 112 and the conductive assembly 12 located on the touch area 111; that is, the conductive assembly 12 located on the border area 112 covers the black mask layer 11 in a stepped manner, causing the conductive assembly 112 to break easily and thus leading to functional failure of the touch screen.

Therefore, in order to ensure accuracy in touch detection, the current industry earnestly needs to develop a new touch screen structure to solve the problem breaking of the conductive assembly in the above-mentioned technology.

### SUMMARY

The present disclosure provides a touch screen that includes a protecting cover comprising a touch area and a border area surrounding the touch area; a black mask layer formed on the border area; and a conductive assembly formed in the touch area, wherein the conductive assembly is isolated from the black mask layer.

The present disclosure further provides a method of manufacturing a touch screen that includes the following steps: forming a black mask layer on a border area of a protecting cover; and forming a conductive assembly in a touch area of the protecting cover, wherein the border area surrounds the touch area, and the conductive assembly is isolated from the black mask layer.

By implementing the disclosure, the situation of the breaking of the conductive assembly will not take place in the touch screen and hence, the problem of functional failure of the touch screen can be avoided.

### BRIEF DESCRIPTION OF THE DRAWINGS

For those skilled in the art, numerous embodiments and drawings described below are for illustration purpose only; and not to limit the scope of the present disclosure in any manner.

FIG. 1 is a schematic stricture diagram of a touch screen in accordance with a prior art.

FIG. 2 is a schematic diagram of a location relation between a transparent conductive assembly and a touch area of a touch screen in accordance with an embodiment of the disclosure.

FIG. 3 is a schematic stricture diagram of a transparent conductive assembly of a touch screen in accordance with an embodiment of the disclosure.

FIG. 4 is a schematic diagram of a structure adding an insulating layer to the structure shown in FIG. 3.

FIG. 5 is a schematic diagram of a structure adding a transparent conductive material and bridging blocks to the structure shown in FIG. 4.

FIG. 6 is a sectional view of the structure along the section line A-A shown in FIG. 5.

FIG. 7 is a schematic diagram of a structure adopting transparent conductive lines in accordance with another embodiment of the disclosure.

FIG. 8 is a sectional view of the structure along the section line B-B shown in FIG. 7; and

FIG. 9 is a flow chart of a manufacturing method of a touch screen in accordance with an embodiment of the disclosure.

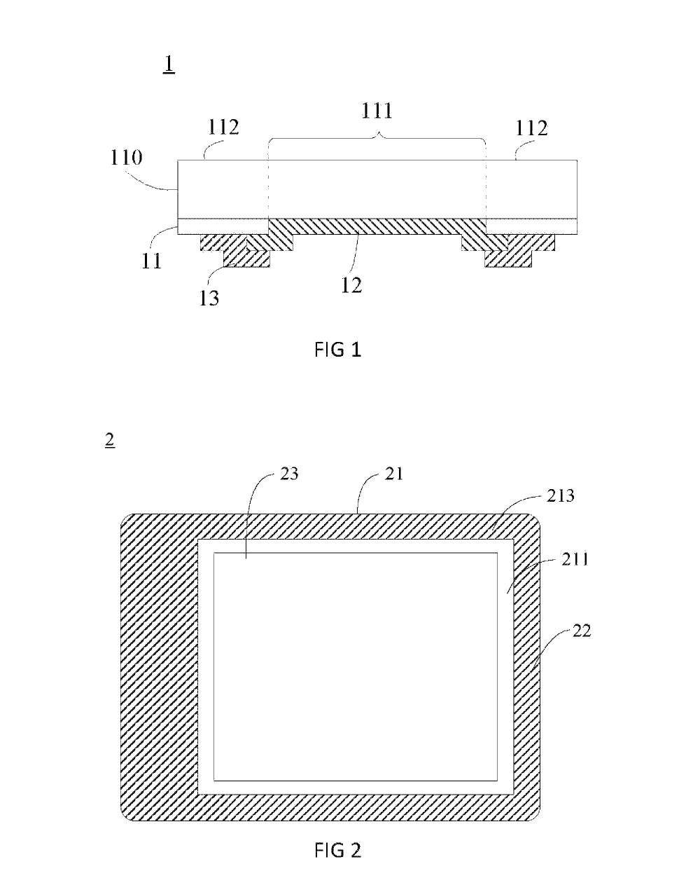

### DETAILED DESCRIPTION

To make the purposes, technical solutions and advantages of the disclosure more explicit, a detailed description is made below combining with drawings and embodiments. It Should be noted that the specific embodiments described herein are only for illustration but not for limitation.

FIG. 2 illustrates a touch screen in accordance with an embodiment of the disclosure. A touch screen 2 includes: a protecting cover 21 which comprises a touch area 211 and a border area 213 surrounding the touch area 211; a black mask layer 22 formed on the border area 213; and a conductive assembly 23 formed in the touch area 211, wherein the conductive assembly 23 is isolated from the black mask layer 22.

In the above-mentioned structure, the conductive assembly 23 is formed in the touch area 211, the black mask layer 22 is formed on the border area 213, such that the conductive assembly 23 does not contact with the black mask layer 22, thereby avoiding the problem of easy breaking of the conductive assembly due to the stepped disposition of the conventional conductive assembly.

The protecting cover 21 is a transparent outer cover made of materials such as transparent silicon glass or PMMA, and is used for protecting the conductive assembly 23 inside the touch screen 2 and providing a touch surface outer surface of the protecting cover 21) for a user to perform touch actions by a finger or a stylus. The touch area 211 of the protecting cover 21 is usually a transparent area which allows the image lights emitted by a display assembly (such as a LCD display assembly) combined with the touch panel 2 to transmit so that the image is resented to the user.

The black mask layer 22 could be made of an insulating black ink and disposed in the border area 213 to make the protecting cover 21 present a black border.

In a borderless design, it creates a visual effect of having a border thereby beautifying the appearance.

The conductive assembly 23 is formed on the protecting cover 21 and limited within the touch area 211, that is, the scope of the touch area 211 is larger than that of the conductive assembly 23. The touch area 211 and the conductive assembly 23 are roughly rectangular in shape. In a preferred embodiment, the conductive assembly 23 is located in the center of the touch area 211, that is, distances between the four edges of the conductive assembly 23 and the four edges of the touch area 211 are equal.

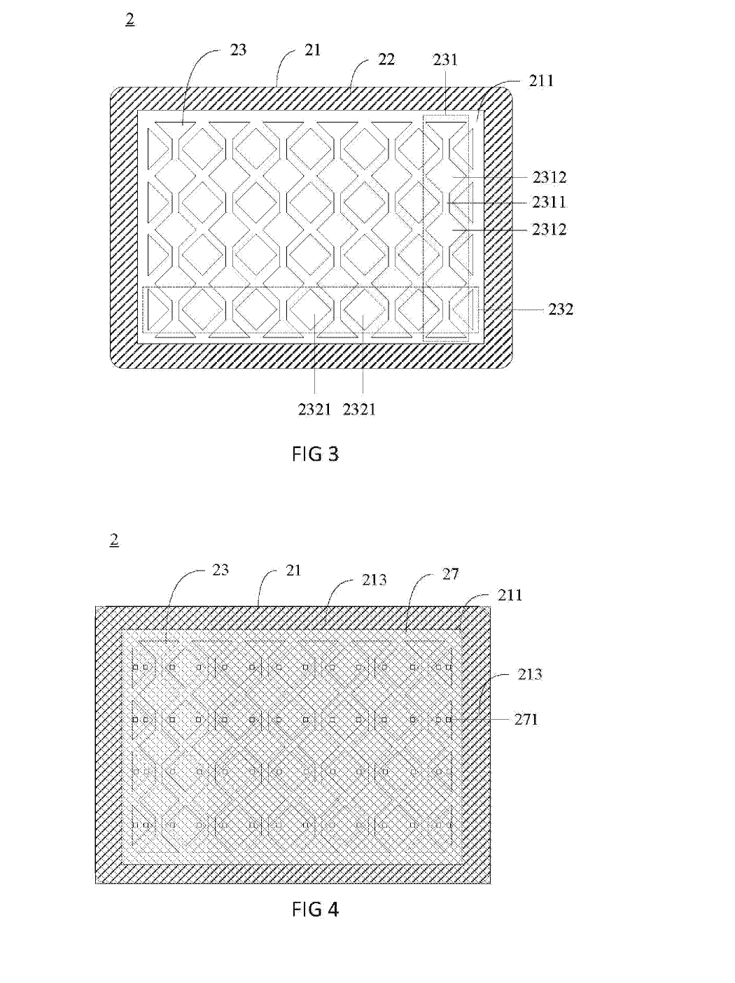

With reference to FIG. 3, the conductive assembly 23 in a preferred embodiment includes: a plurality of longitudinal electrodes 231, each of which comprises a plurality of longitudinal electrode units 2312 arranged in columns; a plurality of connecting lines 2311 electrically connecting two adjacent longitudinal electrode units 2312; and a plurality of transverse electrodes 232, each of which comprises a plurality of transverse electrode units 2321 arranged in rows and disposed at two sides of the connecting lines 2311 at intervals. The serial longitudinal electrodes 231 and the separated transverse electrodes 232 are formed by etching a whole conductive layer which covers the touch area 211, but it is not limited herein. In another embodiment, the longitudinal electrodes 231 and the separated transverse electrodes 232 can be formed by sputtering or printing.

With reference to FIG. 4, the touch screen 2 further comprises an insulating layer 27 firmed on the black mask layer 22 and the conductive assembly 23 and covering the touch area 211 and the border area 213, wherein a plurality of bridging holes 271 are disposed on the insulating layer 27. The bridging boles 271 correspond to the transverse electrode its 2312. With reference to FIG. 5, the touch screen 2 further comprises a plurality of jumpers 273 running through these bridging holes 271 and electrically connecting the corresponding two adjacent transverse electrode units 2321.

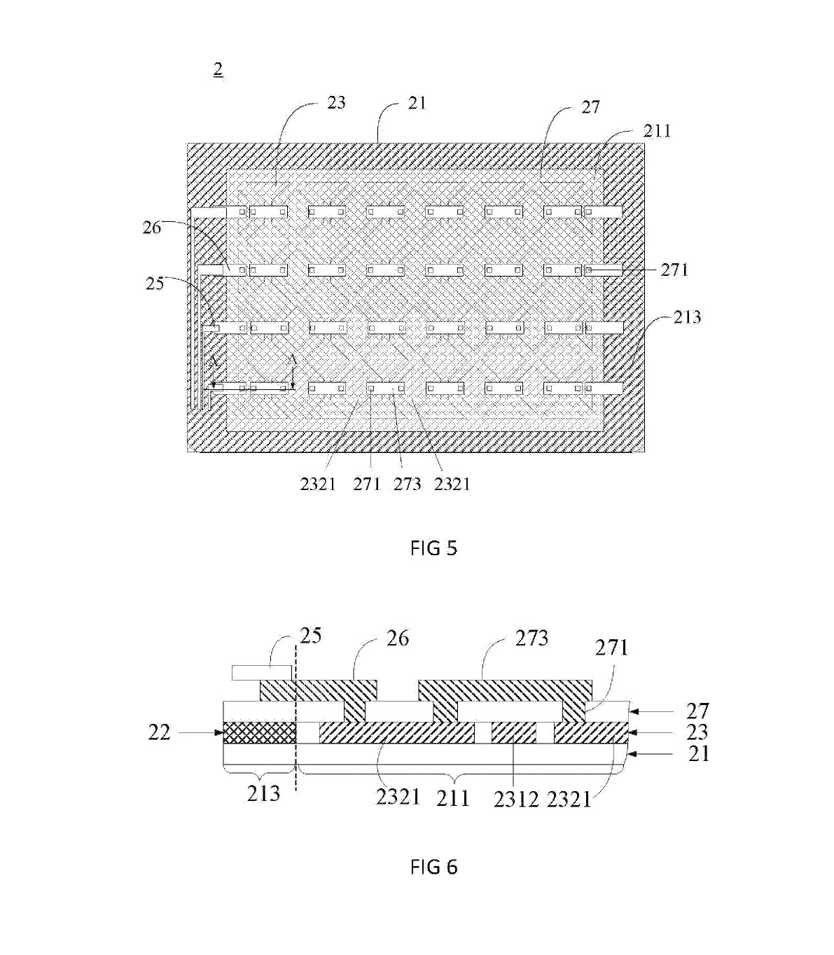

With reference to FIG. 5 and FIG. 6, FIG. 6 is a sectional view of the structure along the section line A-A shown in FIG. 5. The touch screen 2 further comprises a plurality of bridging blocks 26 and conductive wires 25, wherein the conductive wires 25 are electrically connected to the conductive assembly 23 through the bridging holes 271. More specifically, the bridging blocks 26 stretch across the touch area 211 and the border area 213 to rim through the bridging holes 271 such that the transverse electrodes 232 are electrically connected to the conductive wires 25. Meanwhile, one end of the bridging block 26 is electrically connected to the transverse electrode unit 2321 located at the terminal of the transverse electrode 232, and the other end of the bridging block 26 is extended to the border area 213. FIG. 5 only shows the connecting situation between the bridging, blocks 26 and the transverse electrodes 232. The connecting mode between the bridging blocks 26 and the longitudinal electrodes 231 is similar to the connecting mode between the bridging blocks 26 and the transverse electrodes 232.

The protecting cover 21 includes a touch area 211 and a peripheral border area 213. The conductive assembly 23 is formed on the touch area 211 and comprises electrically-connected longitudinal electrode units 2312 and mutually-spaced transverse electrode units 2321. The black mask layer 22 is formed on the border area 213. The insulating layer 27 is formed on the conductive assembly 23 and the black mask layer 22, on which the bridging holes 271 are disposed. And the mutually-spaced transverse electrode units 2321 are electrically connected by the jumpers 273 via the bridging holes 271.

Meanwhile, one end of the bridging block 26 in the peripheral area is electrically connected to the transverse electrode unit 2321 through the bridging hole 271, and the other end is extended to the border area 213 and then electrically connected to the conductive wire 25 located in the border area 213.

The conductive wires 25 can be made of a transparent or non-transparent conductive material such as metallic wire, conductive ink, zinc, oxide or tin oxide. If the conductive wires 25 are made of a colored conductive material, the black mask layer 22 can shield the conductive wires 25 to make them invisible.

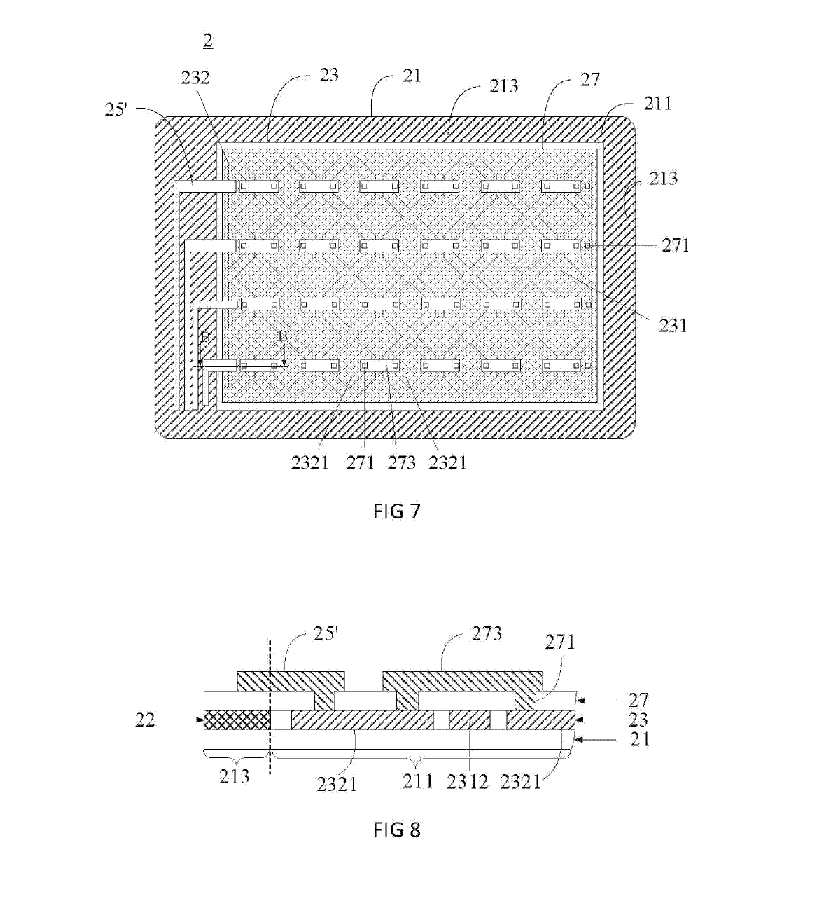

In another embodiment, structural features of the touch screen are similar to those of the foregoing embodiment, and the major distinction lies in the connecting mode between the conductive wires and the conductive assembly, that is, the conductive wires directly stretch into the touch area to conned with the conductive assembly, thereby leaving out the said bridging blocks in the foregoing embodiment. In order to prevent the stretching of the conductive wires into the touch area from being observed by the user, in the present embodiment, the conductive wires are made of a transparent conductive material. With reference to FIG. 7, the transparent conductive wires 25′ stretch across the touch area 211 and the border area 213 and run through the bridging holes 271 to electrically connect with the terminals of the transverse electrodes 232. FIG. 7 only shows the connecting situation between the transparent conductive wires 25′ and the transverse electrodes 232. The connecting mode between the transparent conductive wires 25′ and the longitudinal electrodes 231 is similar to the connecting mode between the transparent conductive wires 25′ and the transverse electrodes 232. The transparent conductive wires 25′ and the conductive assembly 23 are made of the same transparent conductive material. FIG. 8 is a sectional view of the structure along the section line B-B shown in FIG. 7. The protecting cover 21 comprises a touch area 211 and a peripheral border area 213. The conductive assembly 23 is formed on the touch area 211 and comprises electrically-connected, longitudinal electrode units 2312 and mutually-spaced transverse electrode units 2321. The black mask layer 22 is formed on the border area 213. The insulating layer 27 is formed on the conductive assembly 23 and the black mask layer 22, on which the bridging holes 271 are disposed. The mutually-spaced transverse electrode units 2321 are electrically connected by the jumpers 273 via the bridging holes 271.

In another embodiment, the longitudinal electrodes in the. conductive assembly comprise a plurality of longitudinal electrode units disposed at intervals, and the transverse electrodes in the conductive assembly comprise a plurality of transverse electrode units connected by connecting lines. Alternatively, the conductive assembly can be farmed by other patterns as long as the specific touch functions are not affected. In a preferred embodiment, each of the insulating layer 27, the conductive wires 25 and the conductive assembly 23 are transparent Insulating property of the transparent insulating layer is good as it can be used for strengthening the insulating property of the black mask layer 22; meanwhile, flatness of the transparent insulating layer is good as the conductive wires 25 disposed thereon are not easily broken. Moreover, the foregoing jumpers 273 and the bridging blocks 26 are transparent respectively. Since the foregoing elements are all made of transparent materials, a favorable appearance effect can be achieved. In addition, the mode of forming the conductive assembly 23 in other embodiments is not limited to the mode of using the insulating 27 and the jumpers 273 to connect the transverse electrode units 2321, for example, it can be a conventional mode.

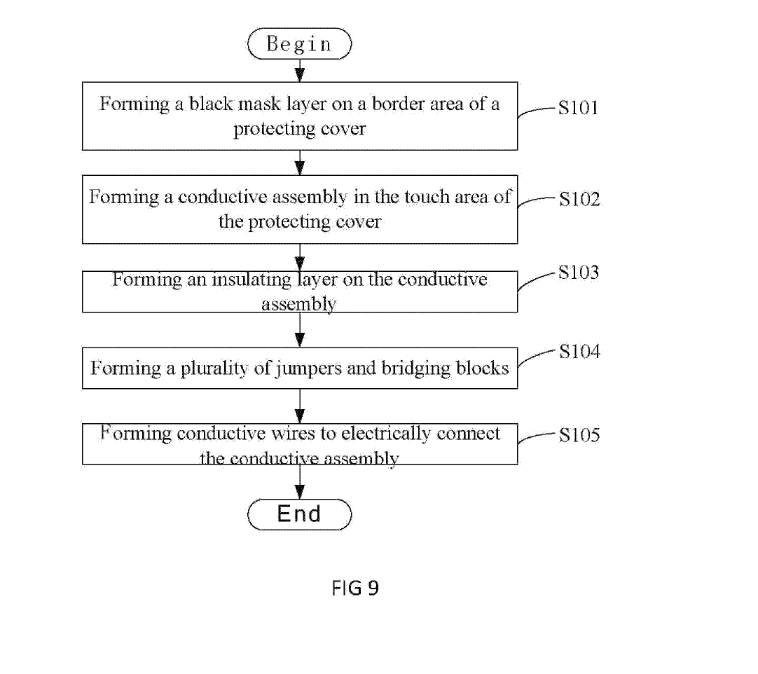

FIG. 9 is a flow chart of a manufacturing method of a touch screen in accordance with an embodiment of the disclosure. The method includes the following steps:

S101: forming a black mask layer on a border area of a protecting cover With reference to FIG. 2, the protecting cover 21 comprises a touch area 211 and a border area 213 surrounding the touch area 211. The black mask layer 22 is formed on the bonier area 213.
S102: forming a conductive assembly in the touch area of the protecting cover. With reference to FIG. 2, the preferred embodiment is that the conductive assembly 23 is formed on and restricted to the touch area 211 such that the conductive assembly 23 is isolated from the black mask layer 22.
With reference to FIG. 3, the conductive assembly 23 comprises:
a plurality of transverse electrodes 232, comprising a plurality of transverse electrode units 2321 arranged in rows;
a plurality of longitudinal electrodes 231, comprising a plurality of longitudinal electrode units 2312 arranged in columns; and
a plurality of connecting lines 2311, electrically connecting two adjacent longitudinal electrode its 2312 and at both sides of which the transverse electrode its 2321 are disposed at intervals.
S103: forming an insulating. layer on the conductive assembly With reference to FIG. 4, the insulating layer 27 covers the whole protecting cover 21. A plurality of bridging holes 271 is disposed on the insulating layer 27. The bridging holes 271 correspond to the transverse electrode units 2312 and are arranged along the extension direction of the transverse electrode units 2321. In the embodiment of FIG. 5, the transverse electrode units are square-shaped, and the bridging holes 271 are located at opposite angles of the squares.
S104: forming a plurality of jumpers and bridging blocks. With reference to FIG. 5, the jumpers 273 are overlaid on the insulating layer 27 and electrically connected to the transverse electrode units 2321 of the conductive assembly 23 through the bridging holes 271. The junipers 273 run through the bridging holes 271 to electrically connect the corresponding two adjacent transverse electrode units 2321. The bridging blocks 26 stretch across the touch area 211 and the border area to run through the bridging holes 271 such that the terminals of the transverse electrodes 232 and the longitudinal electrodes 231 are electrically connected to the subsequently-formed conductive wires.
S105: forming conductive wires to electrically connect the conductive assembly. In the peripheral area adjacent to the touch area 211 and the border area 213 one end of the bridging block 26 is electrically connected to the transverse electrode unit 2321 through the bridging hole 271, and the other end is extended to the border area 213 and then electrically connected to the conductive wire 25 located in the border area 213.

In another embodiment, the transparent conductive wires 25′ shown in FIG. 7 can be formed at the same time when the jumpers 273 are being formed, wherein the transparent conductive wires 25′ stretch across the touch area 211 and the border area 213 and run through the bridging holes 271 to electrically connect the terminals of the transverse electrodes 232, thereby being able to reduce one or more steps in the manufacturing process.

In the foregoing embodiment, the mode of forming the conductive assembly 23 includes printing, sputtering and etching, and the mode of forming the black mask layer 22 and the insulating layer 27 includes exposure and development, or printing. In a preferred embodiment, each of the insulating layer 27, the conductive wires 25 and the conductive assembly 23 are transparent; besides, the jumpers 273 and the bridging blocks 26 are transparent respectively, thereby enabling to achieve a better appearance effect.

In conclusion, for the foregoing touch screen and manufacturing method, the conductive assembly 23 is formed only on the touch area 211 such that it is not overlaid in a stepped manner, thereby avoiding the breaking phenomenon which leads to functional failure of the touch screen; meanwhile, since the conductive assembly 23 and the black mask layer 22 are mutually isolated but not overlapped, the problem of color difference generated due to superposition of the conductive assembly 23 and the black mask layer 22 can be avoided.

While certain embodiments have been shown and described, various modifications and substitutions may be made thereto without departing from the spirit and scope of the disclosure. Therefore, it is to be understood that the present disclosure has been described by way of illustration and not limitations.

What is claimed is:

1. A touch screen, comprising:
a protecting cover, comprising a touch area and a border area surrounding the touch area;
a black mask layer, formed on the border area; and
a conductive assembly, formed in the touch area wherein the conductive assembly is isolated from the black mask layer.

2. The touch screen of claim 1, further comprising an insulating layer and conductive wires, wherein the insulating layer is formed on the black mask layer and the conductive assembly covering the touch area and the border area, wherein a plurality of bridging holes are disposed on the insulating layer, and wherein the conductive wires are electrically connected to the conductive assembly via the bridging holes.

3. The touch screen of claim 2, wherein the conductive assembly comprises:
a plurality of transverse electrodes, each of which comprises a plurality of transverse electrode units arranged in rows;
a plurality of longitudinal electrodes, each of which comprises a plurality of longitudinal electrode units arranged in columns; and
a plurality of connecting lines, electrically connecting two adjacent longitudinal electrode units and at both sides of which the transverse electrode units are disposed at intervals.

4. The touch screen of claim 3, further comprising a plurality of jumpers running through the bridging holes to electrically connect the corresponding two adjacent transverse electrode units.

5. The touch screen of claim 4, further comprising:
a plurality of bridging blocks, stretching across the touch area and the border area and running through the bridging holes such that the terminals of the transverse electrodes and the longitudinal electrodes are electrically connected to the conductive wires.

6. The touch screen of claim 5, Wherein the jumpers and the bridging blocks are transparent respectively.

7. The touch screen of claim 4, wherein the conductive wires stretch across the touch area and border area and run though the bridging holes to electrically connect the terminals of the transverse electrodes and the longitudinal electrodes.

8. The touch screen of claim 1 wherein each of the insulating layer; the conductive wires and the conductive assembly are transparent.

9. A manufacturing method of a touch screen, comprising the following steps of:
forming a black mask layer on a border area of a protecting cover; and
forming a conductive assembly in a touch area of the protecting cover, wherein the border area surrounds the touch area and the conductive assembly is isolated from the black mask layer.

10. The manufacturing method of claim 9, farther comprising: forming an insulating. layer on the black mask layer and the conductive assembly, wherein the insulating layer exposes a plurality of bridging holes and covers the touch area and the border area; and forming conductive wires after forming the insulating layer such that the conductive wires electrically connect the conductive assembly through the bridging holes.

11. The manufacturing method of claim 9, wherein the conductive assembly comprises:
a plurality of transverse electrodes, comprising a plurality of transverse electrode units arranged in rows;
a plurality of longitudinal electrodes, comprising a plurality of longitudinal electrode units arranged in columns; and
a plurality of connecting lines, electrically connecting two adjacent longitudinal electrode units and at both sides of which the transverse electrode units are disposed at intervals.

12. The manufacturing method of claim 11, farther comprising: forming a plurality of jumpers and bridging blocks before forming the conductive wires, wherein the jumpers run through the bridging holes to electrically connect the corresponding two adjacent transverse electrode units, and wherein the bridging blocks stretch across the touch area and the border area and rim through the bridging holes such that the terminals of the transverse electrodes and the longitudinal electrodes are electrically connected to the subsequently-formed conductive wires.

13. The manufacturing method of claim 11, further comprising: forming a plurality of jumpers at the same time when forming the conductive wires, wherein the jumpers run through the bridging holes to electrically connect the corresponding two adjacent transverse electrode units, and wherein the conductive wires stretch across the touch area and the border area and run through the bridging holes to electrically connect the terminals of the transverse electrodes and the longitudinal electrodes.

14. The manufacturing method of claim 9, wherein the mode of forming the conductive assembly includes printing, sputtering and etching.

15. The manufacturing method of claim 9, wherein the mode of forming the black mask layer and the insulating layer includes exposure and development, or printing.

16. The manufacturing method of claim 10, wherein each of the insulating layer, the conductive wires and the conductive assembly are transparent.
